(19) United States
(12) Patent Application Publication
(10) Pub. No.: US 2024/0150860 A1
(43) Pub. Date: May 9, 2024

(54) PROCESS FOR SMELTING HIGH-SPEED STEEL BY USING INTERMEDIATE FREQUENCY FURNACE-LF FURNACE-VD

(71) Applicant: JIANGSU UNIVERSITY, Zhenjiang (CN)

(72) Inventors: Yabo LI, Zhenjiang (CN); Canyang LI, Zhenjiang (CN); Fei WANG, Zhenjiang (CN); Peijie QIN, Zhenjiang (CN)

(73) Assignee: JIANGSU UNIVERSITY, Zhenjiang (CN)

(21) Appl. No.: 18/280,483

(22) PCT Filed: Oct. 13, 2022
(86) PCT No.: PCT/CN2022/125051

§ 371 Date: Sep. 6, 2023

(30) Foreign Application Priority Data
Jan. 19, 2022 (CN) 202210060668.X

(51) Int. Cl. C21C 7/00; C21C 5/52; C21C 7/10; C22C 33/06; C22C 38/00; C22C 38/02; C22C 38/04; C22C 38/06; C22C 38/42; C22C 38/44; C22C 38/46

(52) U.S. Cl. CPC C21C 7/0006; C21C 5/52; C21C 7/0087; C21C 7/10; C22C 33/06; C22C 38/002; C22C 38/02; C22C 38/04; C22C 38/06; C22C 38/42; C22C 38/44; C22C 38/46

(57) ABSTRACT

A process for smelting high-speed steel by using an intermediate frequency furnace-LF furnace-VD includes: firstly, melting a steel material in an intermediate frequency furnace, smelting until the steel material is melted, adjusting chemical components, and then performing deoxidation and slagging; performing electric heating for steel tapping, sending the steel tapping into an LF furnace for smelting, heating to 1470-1510° C., and adjusting the chemical components; and finally, sending these components into a VD furnace for vacuum treatment, and performing steel tapping after the components are qualified. A slagging process in the intermediate frequency furnace is used, then the coarse adjustment of chemical components, the primary deoxidation, and the slagging are performed in the intermediate frequency furnace. After the molten steel is sent to the LF furnace, the slag adjustment can be performed. A content of oxygen in the molten steel can be controlled within 10 ppm after the VD vacuum treatment.

### CROSS REFERENCE TO THE RELATED APPLICATIONS

This application is the national phase entry of International Application No. PCT/CN2022/125051, filed on Oct. 13, 2022, which is based upon and claims priority to Chinese Patent Application No. 202210060668.X, filed on Jan. 19, 2022, the entire contents of which are incorporated herein by reference.

### TECHNICAL FIELD

The present invention relates to the technical field of ferrous metallurgy, and in particular to a process for smelting high-speed steel by using an intermediate frequency furnace-LF furnace-VD.

### BACKGROUND

An electric arc furnace-LF furnace (ladle refining furnace)-VD (vacuum degassing) process is the mainstream process for smelting high-speed steel at present. This process takes an electric arc furnace as a rough smelting furnace that has the main functions of melting raw materials, heating, dephosphorizing, and the like. To ensure the cleanliness of steel, slagging-off is performed after the smelting is completed in the electric arc furnace, slag materials such as lime and the like are added when molten steel is poured into a steel ladle, the steel and the slag materials are mixed to help to slag, and then the steel and the slag materials are transferred to an LF furnace station for refining. The LF furnace has the main functions of deoxidation, accurate adjustment of chemical components of steel, and temperature adjustment, and the VD furnace has the functions of vacuum degassing and H, N, O removal in molten steel, so that the cleanliness of the molten steel is further improved.

However, this process has some defects in practical production. Firstly, a recovery rate of the alloy by using the electric arc furnace smelting is not ideal, and the electric arc furnace smelting is not suitable for smelting high alloy steel; secondly, for helping to slag, the electric arc furnace needs to increase the steel-tapping temperature and prolong the smelting time, which is not beneficial to energy conservation and consumption reduction; and the carbon-oxygen deposit in the molten steel is increased when the temperature is high, resulting in higher oxygen content in the molten steel, which increases the deoxidation burden of the rear process; thirdly, this process has a poor slagging effect, and low-current transmission for slagging is performed specially after the LF furnace, which affects the smelting rhythm; when a large amount of solid slag exists, the arc striking is difficult, and even the danger of breaking an electrode exists; and if pre-melted slag is used for slagging completely, the production cost is greatly increased. Moreover, the steel-tapping temperature of the conventional electric arc furnace is generally required to be above 1600° C., and the oxygen content in molten steel during steel-tapping is up to 80 ppm; however, the higher steel-tapping temperature is not beneficial to energy conservation and emission reduction, and the higher oxygen content increases the difficulty of the subsequent refining and deoxidation process.

Therefore, how to provide a high-speed steel smelting process that has a high alloy recovery rate, meets the requirements of energy conservation and emission reduction, and has high smelting efficiency and good product performance is of important significance for the development of the field of ferrous metallurgy.

### SUMMARY

An objective of the present invention is to provide a process for smelting high-speed steel by using an intermediate frequency furnace-LF furnace-VD, which solves the problems of a low alloy recovery rate, low smelting efficiency, serious environmental pollution, high energy consumption, and poor product performance of the conventional smelting process.

In order to achieve the above objective, the present invention provides the following technical solution.

The present invention provides a process for smelting high-speed steel by an intermediate frequency furnace-LF furnace-VD, which includes the following steps:
(1) rough smelting in the intermediate frequency furnace: melting a steel material in the intermediate frequency furnace, smelting until the steel material is melted, then adding alloy to adjust chemical components to an internal control standard, completely slagging off after the chemical components are qualified, adding aluminum particles for deoxidation at 1.4-1.7 kg/ton of molten steel, then adding a slagging agent to slag, controlling a mass of slag to be 3-5% of a mass of the molten steel, and performing electric heating for steel tapping;
(2) refining in the LF furnace: sending coarsely smelted molten steel in the intermediate frequency furnace into the LF furnace for smelting, performing electric heating to 1470-1510° C., adjusting chemical components to an internal control standard after sampling and analyzing, feeding an aluminum wire 5 min before steel tapping, adjusting a content of aluminum in the molten steel to 0.03-0.05%, calculating a recovery rate of aluminum at 70%, and performing electric heating for steel tapping; and
(3) VD vacuum treatment: sending refined molten steel in the LF furnace into a VD furnace for smelting, closing a cover to extract vacuum, increasing a flow rate of argon after the vacuum degree reaches 67 Pa, ensuring that the molten steel and steel slag do not splash, degassing for 13-20 min, reducing the flow rate of argon, stopping air bleeding, breaking vacuum, adding a heat insulating agent into a steel ladle, adjusting the flow rate of argon to control steel slag to slightly move without exposing the molten steel surface for soft blowing, sampling and analyzing chemical components to an internal control standard, and performing steel tapping after the chemical components are qualified.

Preferably, in the process for smelting high-speed steel by using the intermediate frequency furnace-LF furnace-VD, the steel material in the step (1) is a waste steel material, and the waste steel material is one or more of steel ingot cutting heads, rolling waste, and waste drill bits.

Preferably, in the process for smelting high-speed steel by using the intermediate frequency furnace-LF furnace-VD, the slagging agent in the step (1) is a mixture of lime and fluorite with a mass ratio of 7-10:1.

Preferably, in the process for smelting high-speed steel by using the intermediate frequency furnace-LF furnace-VD, in the step (1) to the step (3), the internal control standards for the chemical components are independently as follows in percentage by weight: C 0.86-0.94%, Mn 0.20-0.35%, Si 0.25-0.35%, S≤0.005%, P≤0.030%, Cr 3.90-4.30%, V 1.80-2.00%, W 6.00-6.30%, and Mo 4.80-5.00%.

Preferably, in the process for smelting high-speed steel by using the intermediate frequency furnace-LF furnace-VD, the molten steel for steel tapping in the step (1) has a temperature of 1530-1550° C.

Preferably, in the process for smelting high-speed steel by using the intermediate frequency furnace-LF furnace-VD, the molten steel for steel tapping in the step (2) has a temperature of 1570-1585° C.

Preferably, in the process for smelting high-speed steel by using the intermediate frequency furnace-LF furnace-VD, the soft blowing in the step (3) is performed for 10-17 min.

Preferably, in the process for smelting high-speed steel by using the intermediate frequency furnace-LF furnace-VD, the molten steel for steel tapping in the step (3) has a temperature of 1475-1485° C.

Preferably, in the process for smelting high-speed steel by using the intermediate frequency furnace-LF furnace-VD, in the step (3), when a furnace type of the VD furnace is 20 t, an initial flow rate of argon for vacuum extraction by closing the cover is 13-16 NL/min, the flow rate of argon is increased to 50-54 NL/min after the vacuum degree reaches 67 Pa, and the flow rate of argon is reduced to 13-16 NL/min after the degassing treatment is performed for 13-20 min.

It can be known from the technical solution that, compared with the prior art, the present invention has the following beneficial effects.
(1) The recovery rate of precious metals such as tungsten, molybdenum, and vanadium in the intermediate frequency furnace can reach more than 90%, the recovery rate of metals such as manganese and chromium can reach more than 95%, and the smelting process has little smoke dust and low noise; compared with the conventional electric arc furnace smelting, this process greatly improves the metal recovery rate and reduces the smoke dust and the noise.
(2) According to the present invention, the slagging process in the intermediate frequency furnace is used, the steel-tapping temperature of the intermediate frequency furnace can be controlled within 1550° C., and the oxygen content in the molten steel is below 40 ppm during steel tapping; however, the steel tapping temperature of the conventional electric furnace is above 1600° C., and the oxygen content in the molten steel is up to above 80 ppm during steel tapping; therefore, the intermediate frequency furnace smelting of the present invention significantly reduces the steel-tapping temperature and the oxygen content in the molten steel, saves energy for the production of enterprises, and reduces the burden for subsequent LF furnace smelting.
(3) The process of the present invention completes slagging in the intermediate frequency furnace, and has a good slagging effect; the mixed flushing of steel and slag can quickly reduce the sulfur content in the steel, and the dust pollution of the mixed flushing slag material is relatively small during steel tapping.
(4) According to the present invention, the high-current transmission can be performed after molten steel is sent to the LF furnace, and the chemical components do not need to be adjusted greatly; the conventional electric furnace process needs special low-current for slagging and large chemical component adjustment, which not only affects the smelting rhythm, but also is difficult to ensure the smelting quality. By adopting the process of the present invention, the sulfur content can generally meet the requirement after the first sampling in LF, the smelting time of the LF furnace can be controlled within 40 min, the oxygen content in the molten steel can be controlled within 15 ppm during steel tapping, and the oxygen content in the molten steel can be controlled within 10 ppm through VD vacuum treatment; when high-speed steel is smelted by the conventional electric arc furnace process, the smelting time of an LF furnace is generally about 60 min, the sulfur content is difficult to control, the oxygen content in LF molten steel is about 20 ppm, and the oxygen content is difficult to be controlled within 15 ppm after VD treatment. Therefore, the process of the present invention greatly reduces the oxygen content and the smelting time, and improves the production efficiency and the steel tapping quality.
(5) According to the present invention, a slagging process in the intermediate frequency furnace is used, then the coarse adjustment of chemical components, the primary deoxidation, and the slagging are performed in the intermediate frequency furnace, after the molten steel is sent to the LF furnace, the temperature can be quickly raised, and the slag adjustment can be performed, so that the LF smelting time can be shortened, and the smelting quality can be ensured.

### DETAILED DESCRIPTION OF THE EMBODIMENTS

The present invention provides a process for smelting high-speed steel by an intermediate frequency furnace-LF furnace-VD, which includes the following steps:
(1) rough smelting in the intermediate frequency furnace: melting a steel material in the intermediate frequency furnace, smelting until the steel material is melted, then sampling and analyzing, adding alloy to adjust chemical components to an internal control standard, completely slagging off after the chemical components are qualified, adding aluminum particles for deoxidation at 1.4-1.7 kg/ton of molten steel, then adding a slagging agent to slag, controlling a mass of slag to be 3-5% of a mass of the molten steel, and performing electric heating for steel tapping;
(2) refining in the LF furnace: sending coarsely smelted molten steel in the intermediate frequency furnace into the LF furnace for smelting, heating to 1470-1500° C. with high-current transmission, adjusting chemical components to an internal control standard after sampling and analyzing, feeding an aluminum wire 5 min before steel tapping, adjusting a content of aluminum in the molten steel to 0.03-0.05%, calculating a recovery rate of aluminum at 70%, and performing electric heating for steel tapping; and
(3) VD vacuum treatment: sending refined molten steel in the LF furnace into a VD furnace for smelting, closing a cover to extract vacuum, increasing a flow rate of argon after the vacuum degree reaches 67 Pa, ensuring that the molten steel and steel slag do not splash, degassing for 13-20 min, reducing the flow rate of argon, stopping air bleeding, breaking vacuum, adding a heat insulating agent into a steel ladle, adjusting the flow rate of argon to control steel slag to slightly move without exposing the molten steel surface for soft blowing, sampling and analyzing chemical components to an internal control standard, and performing steel tapping after the chemical components are qualified.

In the present invention, the high-speed steel smelted is preferably CW6Mo5Cr4V2.

In the present invention, in the step (1) to the step (3), the internal control standards for the chemical components are preferably independently as follows in percentage by weight: C 0.86-0.94%, Mn 0.20-0.35%, Si 0.25-0.35%, S≤0.005%, P≤0.030%, Cr 3.90-4.30%, V 1.80-2.00%, W 6.00-6.30%, and Mo 4.80-5.00%.

In the present invention, before the steel material is melted in the intermediate frequency furnace in the step (1), the steel material also needs to be sorted and cleaned to reduce impurities entering the smelting process.

In the present invention, the steel material in the step (1) is preferably a waste steel material, and the waste steel material is preferably one or more of steel ingot cutting heads, rolling waste, and waste drill bits.

In the present invention, according to the sampling analysis result in the step (1), if the phosphorus content is higher than the internal control standard, the phosphorus content is reduced by adding low-phosphorus pure iron.

In the present invention, the slagging agent in the step (1) is preferably a mixture of lime and fluorite with a mass ratio of 7-10:1, more preferably a mixture of lime and fluorite with a mass ratio of 7.5-9.2:1, and still more preferably a mixture of lime and fluorite with a mass ratio of 8:1.

In the present invention, an amount of aluminum particles added in the step (1) is preferably 1.4-1.7 kg/ton of molten steel, more preferably 1.45-1.62 kg/ton of molten steel, and still more preferably 1.53 kg/ton of molten steel.

In the present invention, the mass of the slag in the step (1) is preferably 3-5% of the mass of the molten steel, more preferably 3.3-4.7% of the mass of the molten steel, and still more preferably 4.1% of the mass of the molten steel.

In the present invention, a temperature of the molten steel for steel tapping in the step (1) is preferably 1530-1550° C., more preferably 1534-1548° C., and still more preferably 1545° C.

In the present invention, a temperature of the electric heating in the step (2) is preferably 1470-1510° C., more preferably 1472-1506° C., and still more preferably 1489° C.

In the present invention, the aluminum content in the molten steel in the step (2) is preferably 0.03-0.05%, more preferably 0.035-0.048%, and still more preferably 0.042%.

In the present invention, a temperature of the molten steel for steel tapping in the step (2) is preferably 1570-1585° C., more preferably 1571-1579° C., and still more preferably 1576° C.

In the present invention, the heat insulating agent in the step (3) is preferably carbonized rice husk.

In the present invention, the time of the degassing treatment in the step (3) is preferably 13-20 min, more preferably 14-19 min, and still more preferably 17 min.

In the present invention, the time of the soft blowing in the step (3) is preferably 10-17 min, more preferably 11-15 min, and still more preferably 14 min.

In the present invention, a temperature of the molten steel for steel tapping in the step (3) is preferably 1475-1485° C., more preferably 1478-1484° C., and still more preferably 1481° C.

In the present invention, when a furnace type of the VD furnace in the step (3) is 20 t, an initial flow rate of argon for vacuum extraction by closing the cover is preferably 13-16 NL/min, more preferably 13.4-15.8 NL/min, and still more preferably 15.2 NL/min; after the vacuum degree reaches 67 Pa, the flow rate of argon is increased to preferably 50-54 NL/min, more preferably 51-53.5 NL/min, and still more preferably 52.6 NL/min; and after the degassing treatment is performed for 13-20 min, the flow rate of argon is reduced to preferably 13-16 NL/min, more preferably 13.1-15.2 NL/min, and still more preferably 13.6 NL/min.

The technical solutions in the examples of the present invention will be clearly and completely described below. Apparently, the described examples are merely a part, rather than all of the examples of the present invention. Based on the embodiments of the present invention, all other embodiments obtained by those of ordinary skill in the art without creative efforts shall fall within the protection scope of the present invention.

### Embodiment 1

In a 20 t intermediate frequency furnace-20 t LF furnace-VD vacuum treatment production line for smelting M2 (CW6Mo5Cr4V2) high-speed steel, internal control standards (in percentage by weight) for chemical components are as follows: C 0.86-0.94%, Mn 0.20-0.35%, Si 0.25-0.35%, S≤0.005%, P≤0.030%, Cr 3.90-4.30%, V 1.80-2.00%, W 6.00-6.30%, and Mo 4.80-5.00%.

The smelting process includes the following steps:
(1) rough smelting in the intermediate frequency furnace: taking steel ingot cutting heads, rolling waste, and waste drill bits as furnace burdens, sorting and cleaning these materials before entering the furnace, and strictly controlling impurities entering the furnace; selecting 20 t of furnace burdens, adding the materials into an intermediate frequency furnace in batches, electrifying for smelting until all materials are melt, measuring the temperature to 1500° C., and sampling and performing spectrum analysis, wherein the first analysis results are shown in Table 1:

TABLE 1
Results of first spectrum analysis in
the intermediate frequency furnace (wt %)

| C | Si | Mn | P | S | Cu | Ni | Cr | V | Al | Mo | W |
|---|---|---|---|---|---|---|---|---|---|---|---|
| 0.84 | 0.29 | 0.23 | 0.025 | 0.015 | 0.05 | 0.06 | 3.60 | 1.53 | 0.003 | 4.55 | 6.10 |

According to the analysis results, 120 kg of ferrochrome (high chromium), 160 kg of ferrovanadium (vanadium 50 wt %), and 130 kg of ferromolybdenum (molybdenum 60 wt %) were added in sequence, the reaction system was powered for 5 min, a sample was taken again for spectrum analysis, and the second analysis results are shown in Table 2:

TABLE 2
Results of second spectrum analysis in the
intermediate frequency furnace (wt %)

| C | Si | Mn | P | S | Cu | Ni | Cr | V | Al | Mo | W |
|---|---|---|---|---|---|---|---|---|---|---|---|
| 0.87 | 0.30 | 0.25 | 0.025 | 0.013 | 0.05 | 0.06 | 4.03 | 1.92 | 0.005 | 4.96 | 6.09 |

According to the analysis results, the chemical components were basically qualified, the furnace body was slightly inclined, and the slag is completely removed; 30 kg of aluminum particles were added, 400 kg of lime, 50 kg of fluorite, and 120 kg of steel-making accelerant were added, the reaction system was powered, the slag surface was continuously stirred by a wood stick to promote slagging, the temperature was measured after the slag was molten, and steel temperature was performed when the temperature was 1550° C.
(2) Refining in the LF furnace: the argon flow rate was adjusted to 110 NL/min before the molten steel was injected into the steel ladle to prevent the air brick from being blocked; after the steel ladle received molten steel, a crane was used to hoist the steel ladle to the LF station, the temperature was measured to be 1478° C., a furnace cover was closed, medium-high current transmission is used, and the argon flow rate was controlled to be 60 NL/min; after 10 min, the temperature was measured to be 1505° C., and a sample was taken for spectral analysis. The first analysis results are shown in Table 3:

TABLE 3
Results of first spectrum analysis in the LF furnace (wt %)

| C | Si | Mn | P | S | Cu | Ni | Cr | V | Al | Mo | W |
|---|---|---|---|---|---|---|---|---|---|---|---|
| 0.88 | 0.31 | 0.26 | 0.026 | 0.005 | 0.05 | 0.06 | 4.04 | 1.93 | 0.035 | 4.96 | 6.09 |

The slag was dipped to observe the color and the fluidity of the slag, it was found that the slag was yellowish, and part of aluminum particles were added to adjust the slag to be white or yellowish white; and the reaction system was continuously powered for 15 min, the temperature was measured to be 1570° C., a sample was taken again for spectrum analysis, and the second analysis results are shown in Table 4:

TABLE 4
Results of second spectrum analysis in the LF furnace (wt %)

| C | Si | Mn | P | S | Cu | Ni | Cr | V | Al | Mo | W |
|---|---|---|---|---|---|---|---|---|---|---|---|
| 0.89 | 0.31 | 0.27 | 0.026 | 0.003 | 0.05 | 0.06 | 4.05 | 1.93 | 0.025 | 4.95 | 6.08 |

The recovery rate of aluminum was calculated at 70%, 4.3 kg of aluminum wires was fed according to the control target of the Al content in the molten steel of 0.04%, the reaction system was powered for 5 min, the temperature was measured to be 1583° C., and steel tapping was performed.
(3) VD vacuum treatment: after the crane was hoisted to a VD station, the temperature was measured to be 1580° C., the cover is closed, vacuum extraction was performed, the initial argon flow rate was 15 NL/min, the working pressure was reached to be 67 Pa after 5 min, the boiling condition of molten steel in the steel ladle was observed through a peephole, the argon flow rate was gradually increased to be 50 NL/min, degassing treatment was performed, after 15 min of degassing treatment, the argon flow rate was adjusted to be 15 NL/min, the vacuum extraction was stopped, the cover was opened after the vacuum breaking, the temperature was measured to be 1505° C., and the heat insulating agent (carbonized rice husk) was added into the steel ladle. The argon flow rate was adjusted to ensure that steel slag slightly moved without exposing the molten steel surface for soft blowing; after soft blowing was performed for 15 min, the temperature was measured to 1481° C., a sample was taken for spectrum analysis, the qualified molten steel was taken as a finished sample for use, and the steel ladle was hoisted to a steel casting position to cast a steel ingot. The oxygen content in the finished product sample was found to be 9 ppm by assay, and the analysis results of the finished product sample are shown in Table 5:

TABLE 5
Results of spectrum analysis of finished product sample (wt %)

| C | Si | Mn | P | S | Cu | Ni | Cr | V | Al | Mo | W |
|---|---|---|---|---|---|---|---|---|---|---|---|
| 0.88 | 0.31 | 0.27 | 0.026 | 0.002 | 0.05 | 0.06 | 4.06 | 1.94 | 0.023 | 4.95 | 6.09 |

### Embodiment 2

In a 20 t intermediate frequency furnace-20 t LF furnace-VD vacuum treatment production line for smelting M2 (CW6Mo5Cr4V2) high-speed steel, internal control standards (in percentage by weight) for chemical components are as follows: C 0.86-0.94%, Mn 0.20-0.35%, Si 0.25-0.35%, S≤0.005%, P≤0.030%, Cr 3.90-4.30%, V 1.80-2.00%, W 6.00-6.30%, and Mo 4.80-5.00%.

The smelting process includes the following steps:
(1) rough smelting in the intermediate frequency furnace: taking steel ingot cutting heads and waste drill bits as furnace burdens, sorting and cleaning these materials before entering the furnace, and strictly controlling impurities entering the furnace; selecting 20 t of furnace burdens, adding the materials into an intermediate frequency furnace in batches, electrifying for smelting until all materials are melt, measuring the temperature to 1492° C., and sampling and performing spectrum analysis, wherein the first analysis results are shown in Table 6:

TABLE 6
Results of first spectrum analysis in the
intermediate frequency furnace (wt %)

| C | Si | Mr | P | S | Cu | Ni | Cr | V | Al | Mo | W |
|---|---|---|---|---|---|---|---|---|---|---|---|
| 0.81 | 0.32 | 0.26 | 0.022 | 0.009 | 0.03 | 0.07 | 3.53 | 1.44 | 0.005 | 4.31 | 6.27 |

According to the analysis results, 140 kg of ferrochrome (high chromium), 175 kg of ferrovanadium (vanadium 60 wt %), and 180 kg of ferromolybdenum (molybdenum 60 wt %) were added in sequence, the reaction system was powered for 8 min, a sample was taken again for spectrum analysis, and the second analysis results are shown in Table 7:

TABLE 7
Results of second spectrum analysis in
the intermediate frequency furnace (wt %)

| C | Si | Mn | P | S | Cu | Ni | Cr | V | Al | Mo | W |
|---|---|---|---|---|---|---|---|---|---|---|---|
| 0.88 | 0.35 | 0.27 | 0.023 | 0.008 | 0.04 | 0.07 | 3.98 | 1.95 | 0.006 | 4.90 | 6.26 |

According to the analysis results, the chemical components were basically qualified, the furnace body was slightly inclined, and the slag is completely removed; 32 kg of aluminum particles were added, 440 kg of lime, 50 kg of fluorite, and 110 kg of steel-making accelerant were added, the reaction system was powered, the slag surface was continuously stirred by a wood stick to promote slagging, the temperature was measured after the slag was molten, and steel temperature was performed when the temperature was 1545° C.
(2) Refining in the LF furnace: the argon flow rate was adjusted to 120 NL/min before the molten steel was injected into the steel ladle to prevent the air brick from being blocked; after the steel ladle received molten steel, a crane was used to hoist the steel ladle to the LF station, the temperature was measured to be 1464° C., a furnace cover was closed, medium-high current transmission is used, and the argon flow rate was controlled to be 65 NL/min; after 12 min, the temperature was measured to be 1498° C., and a sample was taken for spectral analysis. The first analysis results are shown in Table 8:

TABLE 8
Results of first spectrum analysis in the LF furnace (wt %)

| C | Si | Mn | P | S | Cu | Ni | Cr | V | Al | Mo | W |
|---|---|---|---|---|---|---|---|---|---|---|---|
| 0.88 | 0.35 | 0.28 | 0.024 | 0.006 | 0.04 | 0.06 | 3.99 | 1.96 | 0.037 | 4.90 | 6.26 |

The slag was dipped to observe the color and the fluidity of the slag, it was found that the slag was yellowish, and part of aluminum particles were added to adjust the slag to be white; and the reaction system was continuously powered for 17 min, the temperature was measured to be 1558° C., a sample was taken again for spectrum analysis, and the second analysis results are shown in Table 9:

TABLE 9
Results of second spectrum analysis in the LF furnace (wt %)

| C | Si | Mn | P | S | Cu | Ni | Cr | V | Al | Mo | W |
|---|---|---|---|---|---|---|---|---|---|---|---|
| 0.89 | 0.35 | 0.29 | 0.024 | 0.004 | 0.04 | 0.06 | 4.01 | 1.96 | 0.028 | 4.91 | 6.25 |

The recovery rate of aluminum was calculated at 70%, 2.9 kg of aluminum wires was fed according to the control target of the Al content in the molten steel of 0.035%, the reaction system was powered for 5 min, the temperature was measured to be 1579° C., and steel tapping was performed.
(3) VD vacuum treatment: after the crane was hoisted to a VD station, the temperature was measured to be 1575° C., the cover is closed, vacuum extraction was performed, the initial argon flow rate was 14 NL/min, the working pressure was reached to be 67 Pa after 5 min, the boiling condition of molten steel in the steel ladle was observed through a peephole, the argon flow rate was gradually increased to be 53 NL/min, degassing treatment was performed, after 18 min of degassing treatment, the argon flow rate was adjusted to be 16 NL/min, the vacuum extraction was stopped, the cover was opened after the vacuum breaking, the temperature was measured to be 1501° C., and the heat insulating agent (carbonized rice husk) was added into the steel ladle. The argon flow rate was adjusted to ensure that steel slag slightly moved without exposing the molten steel surface for soft blowing; after soft blowing was performed for 13 min, the temperature was measured to 1478° C., a sample was taken for spectrum analysis, the qualified molten steel was taken as a finished sample for use, and the steel ladle was hoisted to a steel casting position to cast a steel ingot. The oxygen content in the finished product sample was found to be 9.6 ppm by assay, and the analysis results of the finished product sample are shown in Table 10:

TABLE 10
Results of spectrum analysis of finished product sample (wt %)

| C | Si | Mn | P | S | Cu | Ni | Cr | V | Al | Mo | W |
|---|---|---|---|---|---|---|---|---|---|---|---|
| 0.88 | 0.35 | 0.29 | 0.024 | 0.003 | 0.04 | 0.06 | 4.02 | 1.96 | 0.027 | 4.91 | 6.25 |

The above descriptions are only preferred embodiments of the present invention. It should be noted that those of ordinary skill in the art can also make several improvements and modifications without departing from the principle of the present invention, and such improvements and modifications shall fall within the protection scope of the present invention.

What is claimed is:

1. A process for smelting high-speed steel by an intermediate frequency furnace-ladle refining (LF) furnace-vacuum degassing (VD), comprising the following steps:
(1) rough smelting in the intermediate frequency furnace: melting a steel material in the intermediate frequency furnace, smelting until the steel material is melted, then adding alloy to adjust chemical components to an internal control standard, completely slagging off after the chemical components are qualified, adding aluminum particles for deoxidation at 1.4 kg/ton-1.7 kg/ton of molten steel, then adding a slagging agent to slag, controlling a mass of slag to be 3%-5% of a mass of the molten steel, and performing electric heating for steel tapping, wherein the molten steel for steel tapping in the step (1) has a temperature of 1530° C.-1550° C.;
(2) refining in the LF furnace: sending coarsely smelted molten steel in the intermediate frequency furnace into the LF furnace for smelting, performing electric heating to 1470° C.-1510° C., adjusting chemical components to an internal control standard after sampling and analyzing, feeding an aluminum wire 5 min before steel tapping, adjusting a content of aluminum in the molten steel to 0.03%-0.05%, calculating a recovery rate of aluminum at 70%, and performing electric heating for steel tapping, wherein the molten steel for steel tapping in the step (2) has a temperature of 1570° C.-1585° C.; and
(3) VD vacuum treatment: sending refined molten steel in the LF furnace into a VD furnace for smelting, closing a cover to extract vacuum, increasing a flow rate of argon after a vacuum degree reaches 67 Pa, ensuring that the molten steel and a steel slag do not splash, degassing for 13 min-20 min, reducing the flow rate of argon, stopping air bleeding, breaking vacuum, adding a heat insulating agent into a steel ladle, adjusting the flow rate of argon to control the steel slag to slightly move without exposing a molten steel surface for soft blowing, sampling and analyzing chemical components to an internal control standard, and performing steel tapping after the chemical components are qualified, wherein the molten steel for steel tapping in the step (3) has a temperature of 1475° C.-1485° C.;
wherein in the step (3), when a furnace type of the VD furnace is 20 t, an initial flow rate of argon for vacuum extraction by closing the cover is 13 NL/min-16 NL/min, the flow rate of argon is increased to 50 NL/min-54 NL/min after the vacuum degree reaches 67 Pa, and the flow rate of argon is reduced to 13 NL/min-16 NL/min after the degassing treatment is performed for 13 min-20 min.

2. The process for smelting high-speed steel by using the intermediate frequency furnace-LF furnace-VD according to claim 1, wherein the steel material in the step (1) is a waste steel material, and the waste steel material is at least one selected from the group consisting of steel ingot cutting heads, rolling waste, and waste drill bits.

3. The process for smelting high-speed steel by using the intermediate frequency furnace-LF furnace-VD according to claim 1, wherein the slagging agent in the step (1) is a mixture of lime and fluorite with a mass ratio of 7-10:1.

4. The process for smelting high-speed steel by using the intermediate frequency furnace-LF furnace-VD according to claim 3, wherein in the step (1) to the step (3), the internal control standards for the chemical components are independently as follows in percentage by weight: C 0.86%-0.94%, Mn 0.20%-0.35%, Si 0.25%-0.35%, S≤0.005%, P≤0.030%, Cr 3.90%-4.30%, V 1.80%-2.00%, W 6.00%-6.30%, and Mo 4.80%-5.00%.

5. The process for smelting high-speed steel by using the intermediate frequency furnace-LF furnace-VD according to claim 1, wherein the soft blowing in the step (3) is performed for 10 min-17 min.

6. (canceled)

7. (canceled)

8. (canceled)

9. (canceled)

10. The process for smelting high-speed steel by using the intermediate frequency furnace-LF furnace-VD according to claim 2, wherein the slagging agent in the step (1) is a mixture of lime and fluorite with a mass ratio of 7-10:1.

11. The process for smelting high-speed steel by using the intermediate frequency furnace-LF furnace-VD according to claim 10, wherein in the step (1) to the step (3), the internal control standards for the chemical components are independently as follows in percentage by weight: C 0.86%-0.94%, Mn 0.20%-0.35%, Si 0.25%-0.35%, S≤0.005%, P≤0.030%, Cr 3.90%-4.30%, V 1.80%-2.00%, W 6.00%-6.30%, and Mo 4.80%-5.00%.
